(19) United States
(12) Patent Application Publication
(10) Pub. No.: US 2026/0049817 A1
(43) Pub. Date: Feb. 19, 2026

(54) GEOMAGNETIC FIELD DISTURBANCE MONITORING AND CORRECTION

(71) Applicant: Lockheed Martin Corporation, Bethesda, MD (US)

(72) Inventors: Peter F. Reardon, Sanford, FL (US); Ralph Ryan Christopher Clement, Orlando, FL (US)

(21) Appl. No.: 19/012,799

(22) Filed: Jan. 7, 2025

Related U.S. Application Data
(60) Provisional application No. 63/684,570, filed on Aug. 19, 2024.

(51) Int. Cl. G01C 17/28; G01C 25/00; G06T 11/20

(52) U.S. Cl. CPC G01C 17/28; G01C 25/00; G06T 11/206; G06T 2200/24

(57) ABSTRACT

Systems, methods, and devices for performing geomagnetic field distribution monitoring and correction. One system includes a reference magnetic sensor configured to detect components of a magnetic field at a first location and generate reference sensor signals, non-transitory computer-readable storage media storing instructions, and at least one electronic processor. The at least one electronic processor is configured to execute the instructions to receive the reference sensor signals from the reference magnetic sensor, compute a local adjustment factor based on the reference sensor signals, receive operational sensor signals from an operational magnetic sensor configured to detect components of the magnetic field at a second location, compute an orientation representation based on the operational sensor signals, and apply the local adjustment factor to the orientation representation to generate a corrected orientation representation.

### CROSS-REFERENCE TO RELATED APPLICATIONS

This application claims the benefit of U.S. Provisional Application No. 63/684,570 filed Aug. 19, 2024. The entire disclosure of the above application is incorporated by reference.

### FIELD

The present disclosure relates to sensor calibration and correction and, more particularly, to sensor calibration and correction based on real-time magnetic field measurements.

### SUMMARY

Magnetic sensors may determine orientation based on the Earth's magnetic field. For example, by detecting the direction and/or strength of the magnetic field relative to the sensor's axes, the sensor's heading or orientation can be computed with respect to magnetic north. Magnetic sensors can be used in a variety of two- or three-dimensional applications. Two dimensional applications include use in navigation systems for land and maritime vehicles to determine the heading of the vehicle, and/or in industrial applications such as in robotics to determine the robot's orientation on a flat plane. Three-dimensional applications include determining the three-dimensional orientation of manned and unmanned aerial vehicles or aircraft as part of an attitude and heading reference system (AHRS), and/or determining the orientation of objects as part of a motion capture system.

However, the Earth's magnetic field varies both spatially and temporally, which presents technical challenges to obtaining accurate magnetic field measurements. These variations may be due to local anomalies (e.g., the presence of magnetized rocks, mineral deposits, tectonic structures, etc.) and/or atmospheric and environmental factors (e.g., ionospheric currents, geomagnetic storms, etc.). Furthermore, local and transient disturbances arising from various natural and/or anthropogenic sources can disrupt the accuracy of magnetic field measurements, further complicating the process of accurately determining orientation using magnetic sensors. Thus, correcting for local variances in the Earth's magnetic field allows for magnetic sensors to provide accurate orientations relative to magnetic geographic references (such as the magnetic north pole).

Additionally, because the Earth's magnetic north pole does not coincide with geographic references such as the geographic north pole, magnetic orientations computed from magnetic sensor measurements may need to be corrected to align with geographic references. Correcting for the difference between the Earth's magnetic north pole and geographic references as well as local variances in the Earth's magnetic field may allow for magnetic sensors to provide accurate orientations relative to geographic references.

However, correcting the magnetic orientations of operational magnetic sensors for local variances and/or to align with true geographical references is complex, particularly when considering the need to continuously adjust for local and/or transient variations in the magnetic field. For example, traditional methods of representing and correcting orientation using rotation matrices can be computationally intensive, leading to inefficiencies in systems requiring real-time or near-real-time updates. In portable systems, computational inefficiencies may lead to detrimental effects such as increased power consumption, reduced battery life, slower processing speeds, and potential overheating, all of which can impair the system's performance reliability, and user experience. In weight-sensitive systems such as those deployed on aircraft, computational inefficiencies can necessitate larger, heavier cooling and power solutions, increasing the overall weight of the system, which may reduce the fuel efficiency of the aircraft.

Systems, apparatuses, methods, and techniques described in this specification provide solutions to these and other technical challenges by using sensor signals from reference magnetic sensors to compute local adjustment factors, such as magnetic declination and inclination (e.g., in real-time or near real-time). These factors may be continuously updated to compensate for both local and transient variations, ensuring that operational magnetic sensors provide accurate orientations. Additionally, multiple reference magnetic sensors may be deployed across an operational area. Each reference magnetic sensor may be used to generate a localized adjustment factor. The localized adjustment factors may be applied to nearby operational magnetic sensors, ensuring localized accuracy for the operational magnetic sensors. Thus, magnetic orientations may be corrected for both local and global (e.g., wide area) magnetic field disturbances.

Furthermore, systems, apparatuses, methods, and techniques described in this specification may employ quaternions to represent and correct orientations. Quaternions provide a more memory-efficient and computational lightweight method compared to conventional techniques such as rotational matrices. Using quaternions also allows systems to avoid issues such as gimbal lock and facilitate interpolation between rotations, making them particularly suitable for critical real-time applications.

According to some examples, a system includes a reference magnetic sensor configured to detect components of a magnetic field at a first location and generate reference sensor signals, non-transitory computer-readable storage media storing instructions, and at least one electronic processor configured to execute the instructions to receive the reference sensor signals from the reference magnetic sensor, compute a local adjustment factor based on the reference sensor signals, receive operational sensor signals from an operational magnetic sensor configured to detect components of the magnetic field at a second location, compute an orientation representation based on the operational sensor signals, and apply the local adjustment factor to the orientation representation to generate a corrected orientation representation.

In other features, the at least one electronic processor is further configured to track a location of an object based on the corrected orientation representation. In other features, the at least one electronic processor is further configured to transmit the corrected orientation representation to a computing system configured to track a location of an object based on the corrected orientation representation. In other features, the local adjustment factor includes a magnetic declination quaternion.

In other features, the local adjustment factor includes a magnetic inclination quaternion. In other features, the orientation representation includes a magnetic heading quaternion. In other features, the orientation representation includes a magnetic declination quaternion. In other features, the corrected orientation representation includes a corrected quaternion and the corrected quaternion represents a three-dimensional orientation of the operational magnetic sensor.

In other features, the local adjustment factor includes a magnetic field magnitude and the corrected orientation representation includes a corrected magnetic field magnitude. In other features, the at least one electronic processor is further configured to render a graphical representation according to the corrected orientation representation on a graphical user interface, the graphical representation depicting a three-dimensional orientation of the operational magnetic sensor.

In other features, the operational magnetic sensor includes a plurality of operational magnetic sensors distributed over a geographical area and the local adjustment factor includes a plurality of local adjustment factors.

Other examples provide a method including receiving, at a sensor processing platform, reference sensor signals from a reference magnetic sensor configured to detect components of a magnetic field at a first location, computing, at the sensor processing platform, a local adjustment factor based on the reference sensor signals, receiving, at the sensor processing platform, operational sensor signals from an operational magnetic sensor configured to detect components of the magnetic field at a second location, computing, at the sensor processing platform, an orientation representation based on the operational sensor signals, applying the local adjustment factor to the orientation representation to generate a corrected orientation representation, and transmitting, from the sensor processing platform, the corrected orientation representation to a computing device. The computing device is configured to track a location of an object based on the corrected orientation representation.

In other features, the local adjustment factor includes at least one of a magnetic declination quaternion and a magnetic inclination quaternion. In other features, the orientation representation includes a magnetic heading quaternion. In other features, the orientation representation includes a magnetic declination quaternion. In other features, the corrected orientation representation includes a corrected quaternion and the corrected quaternion represents a three-dimensional orientation of the operational magnetic sensor.

In other features, the local adjustment factor includes a magnetic field magnitude and the corrected orientation representation includes a corrected magnetic field magnitude. In other features, the computing device is configured to render a graphical representation according to the corrected orientation representation on a graphical user interface, the graphical representation depicting a three-dimensional orientation of the operational magnetic sensor.

Other examples provide a non-transitory computer-readable storage medium including executable instructions that, when executed by at least one electronic processor, causes the at least one electronic processor to receive reference sensor signals from a reference magnetic sensor configured to detect components of a magnetic field at a first location, compute a local adjustment factor based on the reference sensor signals, receive operational sensor signals from an operational magnetic sensor configured to detect components of the magnetic field at a second location, compute an orientation representation based on the operational sensor signals, apply the local adjustment factor to the orientation representation to generate a corrected orientation representation; and transmit the corrected orientation representation to a computing device. The computing device is configured to track a location of an object based on the corrected orientation representation.

Other examples provide a device including an operational magnetic sensor configured to detect components of a magnetic field at a first location, non-transitory computer-readable storage media storing instructions, and at least one electronic processor configured to execute the instructions to receive reference sensor signals from a reference magnetic sensor configured to detect components of the magnetic field at a second location, compute a local adjustment factor based on the reference sensor signals, compute an orientation representation based on operational sensor signals from the operational magnetic sensor, and apply the local adjustment factor to the orientation representation to generate a corrected orientation representation.

Other examples, embodiments, features, and aspects will become apparent by consideration of the detailed description and accompanying drawings.

### BRIEF DESCRIPTION OF THE DRAWINGS

FIG. 1A is a block diagram illustrating an example magnetic sensor system, according to some embodiments.

FIG. 1B is a block diagram illustrating another configuration of a magnetic sensor system, according to some examples.

FIG. 2 is a chart illustrating a graphical representation of magnetic field vectors, according to some embodiments.

FIG. 3 is a chart illustrating pitch, roll, and yaw axes with respect to an east, north, up coordinate system, according to some embodiments.

FIG. 4 is a chart illustrating effects of changing a pitch of a magnetic sensor, according to some embodiments.

FIG. 5 is a chart illustrating three related reference frames, according to some embodiments.

FIG. 6 is an isometric view illustrating an example of a reference magnetic sensor system, according to some embodiments.

FIG. 7 is a message sequence chart illustrating example interactions between components of a magnetic sensor system, according to some embodiments.

FIG. 8 is a flowchart illustrating an example process for computing local adjustment factors based on sensor signals from a reference magnetic sensor system, according to some embodiments.

FIG. 9 illustrates an example process for computing magnetic orientation representations.

FIG. 10 is a schematic illustration of relationships between local adjustment factors and magnetic orientations, according to some embodiments.

FIG. 11 illustrates an example graphical user interface, according to some embodiments.

FIG. 12 is a block diagram illustrating an exemplary deployment of a magnetic sensor system, according to some embodiments.

FIG. 13 is a block diagram illustrating an exemplary deployment of a magnetic sensor system, according to some embodiments.

FIG. 14 is a block diagram illustrating an exemplary deployment of a magnetic sensor system, according to some embodiments.

FIG. 15 is a block diagram illustrating data flows between components of a magnetic sensor system, according to some embodiments.

FIG. 16 is a schematic diagram illustrating the alignment of the north axis of a reference magnetic sensor system with geographic north indicated by a geographic north finder, according to some embodiments.

In the drawings, reference numbers may be reused to identify similar and/or identical elements.

### DETAILED DESCRIPTION

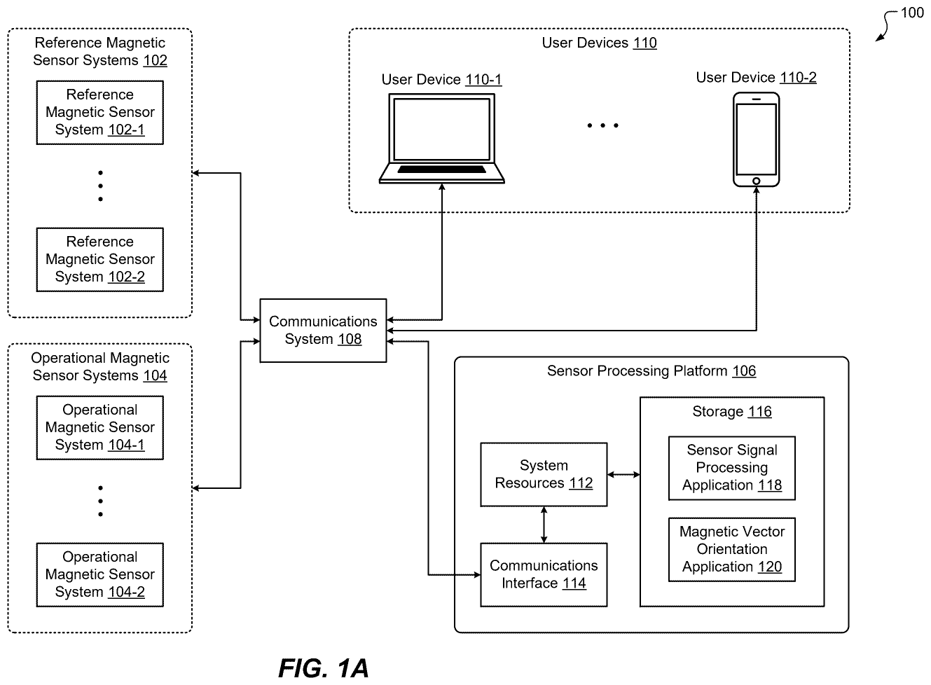

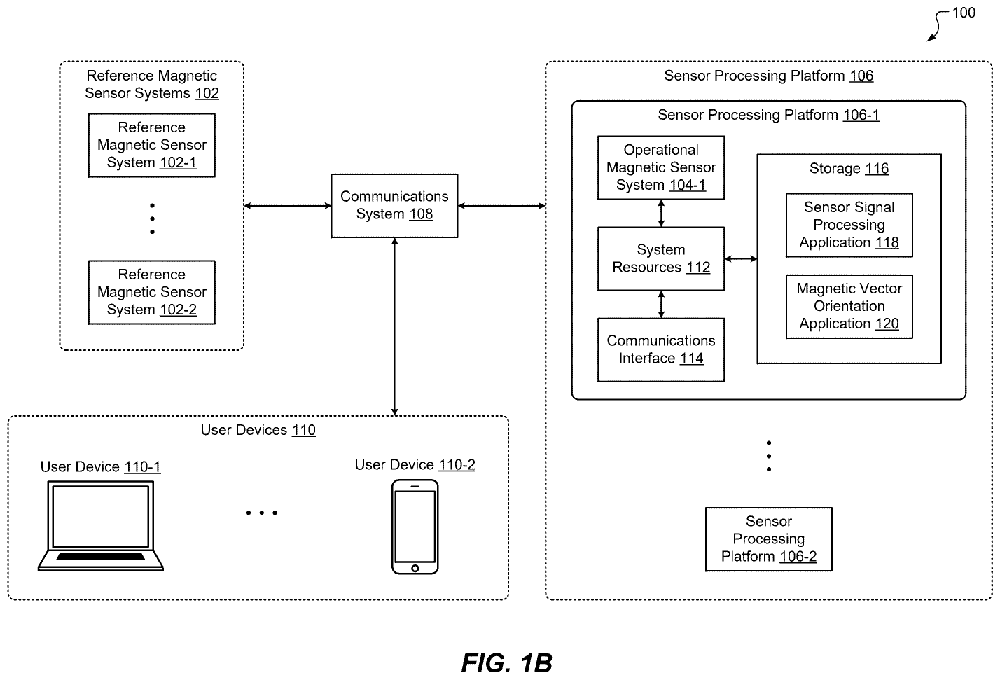

FIG. 1A is a block diagram illustrating an example magnetic sensor system 100, according to some embodiments. The system 100 may include one or more reference magnetic sensor systems 102 and one or more operational magnetic sensor systems 104 that communicate with a sensor processing platform 106 via a communications system 108. The system 100 may also include one or more user devices 110 (such as, for example, user devices 110-1 and 110-2). that communicate with the sensor processing platform 106 via the communications system 108. Although two user devices 110-1 and 110-2 are shown in FIG. 1A, the system 100 may include any number of user devices 110.

The reference magnetic sensor systems 102 and the operational magnetic sensor systems 104 may include one or more magnetic sensors that generate sensor data from which magnetic field strengths and components can be computed. Examples of suitable magnetic sensors include magnetometers (such as fluxgate magnetometers, MEMs magnetometers, Overhauser magnetometers, etc.), Hall effect sensors, anisotropic magnetoresistive sensors (AMR), etc. The reference magnetic sensor system 102 and the operational magnetic sensor systems 104 may also include one or more position sensors, such as a Global Positioning System (GPS) receiver, a Global Navigation Satellite System (GLONASS) receiver, a Galileo receiver, a BeiDou receiver, a cellular modem, a Wi-Fi module, an inertial measurement unit (IMU), an ultra-wideband (UWB) receiver, etc. Although two reference magnetic sensor systems 102 and two operational magnetic sensor systems 104 are shown in FIG. 1A, the system 100 may include any number of reference magnetic sensor systems 102 and any number of operational magnetic sensor systems 104.

The sensor processing platform 106 may be implemented by a wide range of computing platforms. For example, the sensor processing platform 106 may be implemented by traditional computing systems such as desktop computers, laptop computers, workstations, servers, etc. In various implementations, the sensor processing platform 106 is implemented by mobile and/or wearable devices, such as smartphones, tablets, smart watches, smart glasses, etc. In some examples, the sensor processing platform 106 is implemented by immersive computing devices, such as augmented reality (AR) devices, virtual reality (VR) devices, mixed reality (MR) devices, etc. Although a single sensor processing platform 106 is illustrated in the example of FIG. 1A, the system 100 may include any number of sensor processing platforms 106, and the various processing steps described herein may be performed at a single sensor processing platform 106 and/or distributed across multiple sensor processing platforms 106, as may be suitable for the particular implementation. Additionally or alternatively, the various processing steps described herein may be further performed at and/or distributed across other components of the system 100, such as, for example, the reference magnetic sensor systems 102, the operational magnetic sensor systems 104, and/or the user devices 110.

The sensor processing platform 106 may include system resources 112, a communications interface 114, non-transitory computer-readable storage media, such as, for example, storage 116. The non-transitory computer-readable storage media may contain instructions that, when executed, cause one or more electronic processors (such as, for example, electronic processors of the system resources 112) to perform various functions described herein. The system resources 112 may include one or more electronic processors, one or more graphics processing units, volatile computer memory, non-volatile computer memory, and/or one or more system buses interconnecting various components of the sensor processing platform 106. The communications interface 114 may include hardware and/or software components that communicate with other devices, platforms, and/or systems over the communications system 108. In various implementations, the communications interface 114 includes one or more transceivers for sending and/or receiving data over the communications system 108.

In various implementations, the communications system 108 includes one or more types of networks to facilitate connectivity and data transmission. These may include mobile networks such as General Packet Radio Service (GPRS), Time-Division Multiple Access (TDMA), Code-Division Multiple Access (CDMA), Global System of Mobile Communications (GSM), Enhanced Data Rates for GSM Evolution (EDGE), High-Speed Packet Access (HSPA), Evolved High-Speed Packet Access (HSPA+), Long Term Evolution (LTE), Worldwide Interoperability for Microwave Access (WiMAX), and 5th-generation mobile networks (5G). Additionally, the communications system 108 may incorporate an Internet Protocol (IP) network, a Wireless Application Protocol (WAP) network, or an IEEE 802.11 standards network, as well as any suitable combination of these networks.

The communications system 108 may also include other network types, such as optical networks, local area networks (LANs), and global communication networks like the Internet. In some implementations, the communications system 107 may be implemented according to one or more serial communication standards, including RS-232, RS-485, Universal Asynchronous Receiver/Transmitter (UART), Inter-Integrated Circuit (I2C), Serial Peripheral Interface (SPI), and Universal Serial Bus (USB). Furthermore, the communications system 108 may include a Controller Area Network (CAN). In various implementations, the communications system 108 includes personal area networks (PANs) such as Bluetooth and Zigbee, allowing for short-range, wireless communication.

The storage 116 may include a sensor processing application 118 and/or a magnetic vector orientation application 120. The sensor signal processing application 118 may receive sensor signals from the reference magnetic sensor systems 102 and compute local adjustment factors for each reference magnetic sensor system 102. Local adjustment factors, such as magnetic declination and inclination, may be used to correct magnetic sensor readings to account for variations in the Earth's magnetic field at specific locations (e.g., at the respective reference magnetic sensor system 102). Magnetic declination may refer to the angular difference between the north-pointing vector of the local magnetic field and geographic north. Magnetic inclination (also referred to as the magnetic dip) refers to the angular difference between the direction of the local magnetic field vector and the local horizontal plane. Thus, magnetic inclination may describe the angle at which the local magnetic field lines intersect the Earth's surface.

The sensor signal processing application 118 may monitor the sensor signals from the reference magnetic sensor systems 102 and continuously generate local adjustment factors in real time or near-real time (for example, at about 15 Hz) so that the local adjustment factors can effectively compensate for both local and transient variations in the Earth's magnetic field. For example, local anomalies, such as magnetized rocks, mineral deposits, and/or tectonic structures may cause deviations in the magnetic field's direction and/or strength, disrupting the local magnetic field from its average state. Additionally, atmospheric and/or environmental factors such as ionospheric currents and/or geomagnetic storms can induce temporary fluctuations in the Earth's magnetic field. By continuously updating local adjustment factors in real-time or near-real-time, the system 100 ensures that these adjustment factors reflect current local conditions, thereby maintaining accurate compensation for both ongoing local and/or transient disturbances.

The sensor signal processing application 118 may monitor sensor signals from the operational magnetic sensor systems 104, compute a magnetic orientation representation, and integrate local adjustment factors to derive a corrected orientation representation. Such techniques allow for the real time or near-real time correction of the operational magnetic sensor systems 104, accommodating both local anomalies and transient disturbances (as may be appropriate in any given application). As a result, the corrected orientation representation accurately reflects the orientation of each operational magnetic sensor system 104 relative to the true geographic reference frame. The magnetic vector orientation application 120 may generate a graphical representation of the corrected orientation representation and/or position of one or more of the operational magnetic sensor systems 104. For example, the magnetic vector orientation application 120 may generate a graphical user interface at the sensor processing platform 106 and output the corrected orientation representations and/or positions via the graphical user interface.

In various implementations, the user devices 110 include one or more computing platforms, such as smartphones, tablet computers, laptop computers, desktop computers, computer servers, etc. The user devices 110 may access the magnetic vector orientation application 120 via the communications system 108. The magnetic vector orientation application 120 may provide a corrected orientation representation (such as a true orientation vector) and/or a position of each operational magnetic sensor system 104 to the user devices 110.

The user devices 110 may generate and represent the corrected orientation representation and/or position of each operational magnetic sensor system 104 on the graphical user interface. Alternatively, the magnetic vector orientation application 120 may generate the graphical user interface, and the user devices 110 may access the graphical user interface via the communications system 108.

FIG. 1B is a block diagram illustrating another configuration of the magnetic sensor system 100, according to some examples. In the example of FIG. 1B, each operational magnetic sensor system 104 may be integrated with a respective sensor processing platform 106, which may perform various processing steps described herein “at the edge” (e.g., locally at each operational magnetic sensor system 104). For example, as illustrated in FIG. 1B, the operational magnetic sensor system 104-1 may be integrated with a respective sensor processing platform 106-1. Similarly, the operation magnetic sensor system 104-2 (not shown) may be integrated with a respective sensor processing platform 106-2. In various implementations, the operational magnetic sensor system 104 and the respective sensor processing platform 106 are integrated into a single physical unit. In some examples, the operational magnetic sensor system 104 and the respective sensor processing platform 106 may be separate physical units that are substantially co-located and in communication via a wired or short-range wireless communications system. Implementing the sensor processing platform 106 in such “edge” configurations may reduce the latency associated with the various processing steps described herein.

In some examples, the reference magnetic sensor systems 102 and/or the operational magnetic sensor systems 104 are implemented using magnetic sensors such as magnetometers. A magnetometer may include a sensor that measures the strength and direction of magnetic fields, such as the Earth's magnetic field. Magnetic sensors such as magnetometers detect the magnetic field relative to their own orientation in space, operating within a local coordinate system known as the sensor frame. However, to determine an orientation that is consistent with other sensors or global references, the measured magnetic field data often needs to be translated into a global coordinate system, referred to as the navigation frame. This translation may be achieved through rotations described by angles such as roll, pitch, and yaw, which are mathematically represented using rotation matrices or quaternions.

The magnetic sensor may record a magnetic field vector \vec{m}. When the magnetic field vector \vec{m} is not changing for a period of time, the magnetic field vector \vec{m} is a constant vector. However, when the magnetic sensor is moved, the magnetic field vector \vec{m} also changes. For example, a magnetic sensor deployed to Orlando, Florida pointing to geographic north and level with the horizontal or ground plane may output a magnetic field vector \vec{m} (for example, in microtesla (μT)) in an east, north, up (ENU) coordinate system according to Equation (1) below:

$$\vec{m} = 〈 - 2.932 , 24.4592 , - 37.6074 〉 μ T \qquad ( 1 )$$

When the magnetic sensor is oriented to magnetic north and level with the ground plane, the magnetic sensor may output a magnetic field vector \vec{m} according to Equation (2) below:

$$\vec{m} = 〈 0. , 24.4592 , - 37.6074 〉 μ T \qquad ( 2 )$$

Despite the change in direction, the magnitude |\vec{m}| of the magnetic field vector \vec{m} may remain constant and computed according to Equation (3) below:

$$\vert \vec{m} \vert = \sqrt{{{m}_{E}}^{2} + {{m}_{N}}^{2} + {{m}_{U}}^{2}} \qquad ( 3 )$$

In Equation (3), m_{E}, m_{N}, and m_{U} represent the components of the magnetic field vector \vec{m} along the east, north, and up axes, respectively. The magnitude |\vec{m}| of the magnetic field vectors \vec{m} of both Equations (1) and (2) may be about 44.9574 μT.

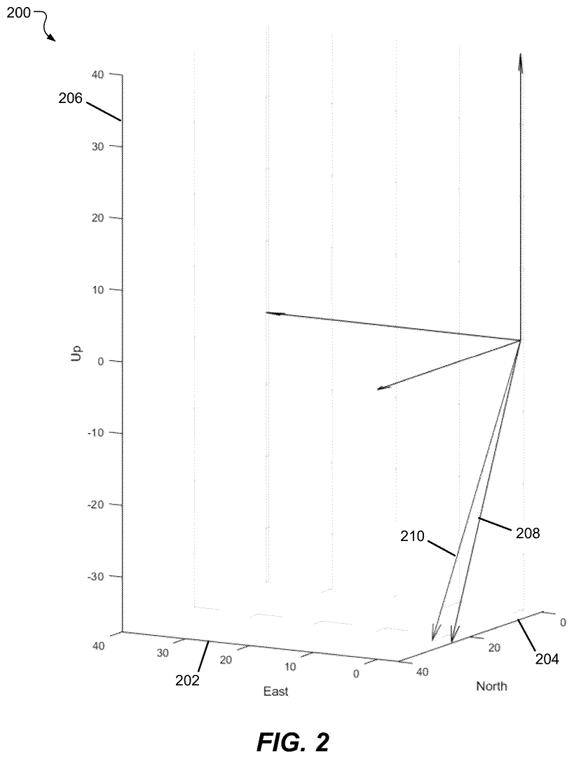

FIG. 2 is a chart 200 illustrating a graphical representation of the magnetic field vectors \vec{m} of Equation (1) and Equation (2), according to some embodiments. In the chart 200, the x-axis 202 represents the east component of each magnetic field vector \vec{m}, the y-axis 204 represents the north component of each magnetic field vector \vec{m}, and the z-axis 206 represents the up component of each magnetic field vector \vec{m}. The vector 208 represents the magnetic field vector \vec{m} of Equation (1), which corresponds to the magnetometer deployed to Orlando, Florida pointing to geographic north and level with the ground place. The vector 210 represents the magnetic field vector \vec{m} of Equation (2), which corresponds to the magnetometer deployed to Orlando, Florida after it has been reoriented to magnetic north and level with the ground plane.

A declination angle [symbol] may measure an angular difference between geographic north and the magnetic field vector m in the horizontal or ground plane. The declination angle may be computed according to Equation (4) below:

$$= a tan ( \frac{{m}_{E}}{{m}_{N}} ) \qquad ( 4 )$$

In Equation (4), the declination angle [symbol] is computed as a function of the east component mg and the north component m_{N} of the magnetic field vector m. In the example where the magnetic sensor is deployed to Orlando, Florida, the declination angle [symbol] may be about −6.8°, indicating a westerly deviation from geographic north. The declination angle [symbol] being about −6.8° corresponds to a clockwise (cw) rotation of the magnetic north vector or, similarly, a counterclockwise (ccw) rotation of the reference frame used by the magnetic sensor.

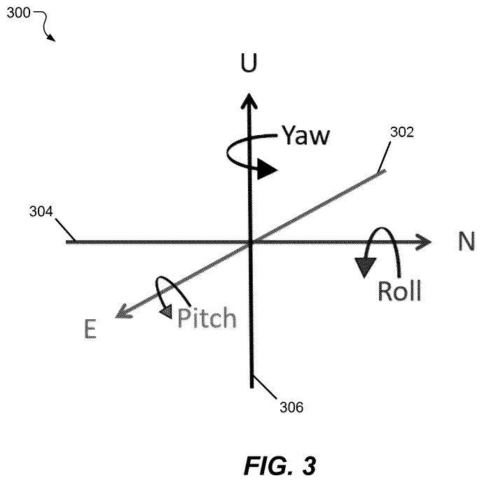

In the previously described examples of Equations (1) and (2), the magnetic sensor is level with the ground plane. However, in other practical real-world applications, magnetic sensors may not be perfectly level with the ground plane. FIG. 3 is a chart 300 illustrating pitch, roll, and yaw axes with respect to the ENU coordinate system, according to some embodiments. As illustrated in the chart 300, pitch or changes in pitch may describe angular rotations 8 about the east component 302. Roll or changes in roll may describe angular rotations a about the north component 304. Yaw or changes in yaw may describe angular rotations y about the up component 306. Mathematically, pitch, roll, and yaw may be expressed in matrix notation or as matrix representations. For example, roll may be expressed according to Equation (5) below:

$$Roll = [ \begin{matrix}1 & 0 & 0 \\ 0 & cos ( α ) & - sin ( α ) \\ 0 & sin ( α ) & cos ( α )\end{matrix} ] \qquad ( 5 )$$

Pitch may be expressed according to Equation (6) below:

$$Pitch = [ \begin{matrix}cos ( β ) & 0 & sin ( β ) \\ 0 & 1 & 0 \\ - sin ( β ) & 0 & cos ( β )\end{matrix} ] \qquad ( 6 )$$

Yaw may be expressed according to Equation (7) below:

$$Yaw = [ \begin{matrix}cos ( γ ) & - sin ( γ ) & 0 \\ sin ( γ ) & cos ( γ ) & 0 sin ( α ) \\ 0 & 0 & 1\end{matrix} ] \qquad ( 7 )$$

Thus, when the magnetic sensor is pitched down by about 7°, the declination angle [symbol] dec decreases by about 1°. Rolling the magnetic sensor yields a similar result.

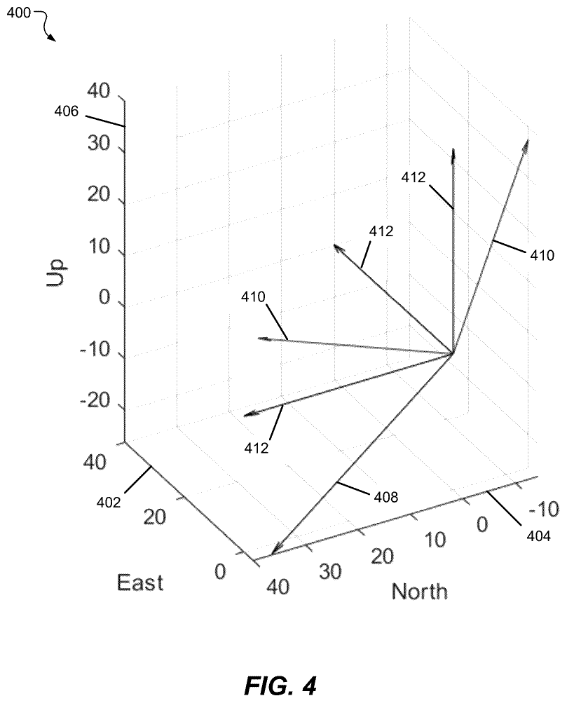

FIG. 4 is a chart 400 illustrating the effects of changing the pitch of the magnetic sensor, according to some embodiments. In the chart 400, the x-axis 402 represents the cast component, the y-axis 404 represents the north component, and the z-axis 406 represents the up component. The chart 400 illustrates the effects of pitching the magnetic sensor downward by about 21°. As illustrated in the chart 400, the geographic north vector is represented as the vector 408, which remains consistent in the global coordinate system. The original, level (unpitched) ENU reference frame is depicted by the vectors 410. After the magnetic sensor is pitched downward, the new orientation of the sensor frame is illustrated by the vectors 412.

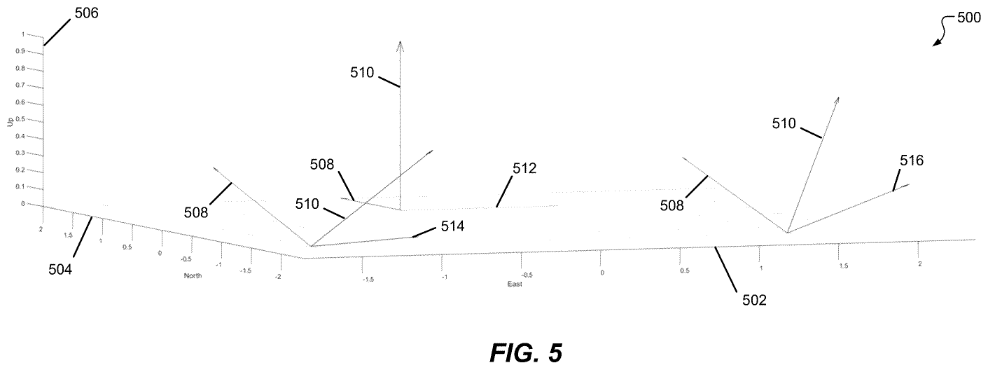

FIG. 5 is a chart 500 illustrating three related reference frames, according to some embodiments. In the chart 500, the x-axis 502 represents the east component, the y-axis 504 represents the north component, and the z-axis 506 represents the up component. Each of the three reference frames (or coordinate systems) includes a vector 508 representing north and a vector 510 representing up. In the ENU reference frame including the vector 512, the axes of the reference frame are parallel to the axes 502, 504, and 506. The reference frame including the vector 514 has been rolled by about 30°, pitched by about 30°, and yawed by about 30° (in order). The reference frame including the vector 516 has been yawed by about 30°, pitched by about 30°, and rolled by about 30° (in order).

Each of the three reference frames have different origins but are related by the sets of rotations. When the rotations between reference frames are known, the orientation of an object in one reference frame can be transformed to orientations to the other reference frames. For example, as previously described with reference to Equations (5)-(7), the roll between reference frames may be expressed by a roll matrix R, the pitch between reference frames may be expressed by a pitch matrix P, and the yaw between reference frames may be expressed by a yaw matrix Y. The reference frame including the including the vector 512 may be represented by FG, the reference frame including the vector 514 may be represented by FB, and the reference frame including the vector 516 may be represented by FR. To transform orientations from the reference frame FG to the reference frame FB, the rotation matrices describing the rotations are multiplied with the reference frame FG in reverse order, as illustrated by Equation (8) below:

$$FB = Y * P * R * FG \qquad ( 8 )$$

Similarly, to transform orientations from the reference frame FG to the reference frame FR, the rotation matrices describing the rotations are multiplied with the reference frame FG in reverse order, as illustrated by Equation (9) below:

$$FB = R * P * Y * FG \qquad ( 9 )$$

Generally, the relationship between the 3D Cartesian reference frames can be expressed by a single rotation matrix. For example, the rotation matrices used to transform the reference FG to the reference frame FB in Equation (9) above can be expressed as a rotation matrix U, according to Equation (10) below:

$$U ≡ R * P * Y \qquad ( 10 )$$

Thus, the transformation of Equation (9) can be expressed as a function of the rotation matrix U, according to Equation (11) below:

$$FB = U * FG \qquad ( 11 )$$

Using rotation matrices U to transform between reference frames may include a variety of practical benefits. For example, as indicated by Equation (12) below, rotation matrices U may be orthogonal:

$${U}^{T} = {U}^{- 1} \qquad ( 12 )$$

Thus, the rotation matrix U preserves the geometric properties (e.g., lengths, angles, etc.) of any vectors it transforms. This may be because the rotation matrix U only rotates vectors and does not change their shape or magnitude. For example, vector w and vector v may be elements of a three-dimensional real vector space [symbol] . The rotation matrix U describes the transformation between the vector w and vector v, as illustrated in Equation (13) below:

$$w = Uv \qquad ( 13 )$$

Equation (14) below expresses the computation of the length of the vector w:

$${\vert w \vert}^{2} = {w}^{T} w = {( Uv )}^{T} ( Uv ) = {v}^{T} {U}^{T} Uv = {v}^{T} v = {\vert v \vert}^{2} \qquad ( 14 )$$

Equation (14) illustrates that the length of a vector is not changed by the rotation (or by the transformation to a different reference frame). Vector a and vector b may be two additional vectors that are elements of the three-dimensional vector space [symbol] . Vector a may be rotated by the rotation matrix U into vector v, as illustrated by Equation (15) below:

$$v = Ua \qquad ( 15 )$$

Vector b may be rotated by the rotation matrix U into vector w, as illustrated by Equation (16) below:

$$w = Ub \qquad ( 16 )$$

The dot product between the vectors w and v may be equal to the dot products between vectors a and b, as illustrated by Equation (17) below:

$$w \cdot v = \vert w \vert \vert v \vert cos ( θ ) = \vert Ub \vert \vert Ua \vert cos ( θ ) = \vert b \vert \vert a \vert cos ( θ ) = a \cdot b \qquad ( 17 )$$

Thus, Equations (15)-(17) demonstrate that, when the rotation matrix U is used to transform multiple vectors, the angles between the vectors in the old reference space are preserved when the vectors are transformed into the new reference space.

Additionally, rotation matrices U may be used to transform the difference between two vectors from one reference space to another reference space. For example, the difference Δ_{wv} between vectors w and v may be defined according to Equation (18) below:

$${Δ}_{wv} ≡ w - v \qquad ( 18 )$$

As illustrated by Equation (19) below, the difference Δ_{wv} between vectors w and v, which are the vectors b and a have been transformed by the rotation matrix U into the new reference frame, is the same as the difference Aba between vectors b and a in the original reference frame:

$${Δ}_{wv} = w - v = Ub - Ua = U ( b - a ) = U {Δ}_{ba} \qquad ( 19 )$$

Thus, Equation (19) illustrates that the difference Δ_{wv} between vectors w and v, after the vectors b and a in the original reference frame have been rotated by the rotation matrix U, is equivalent to rotating the difference vector Aba by the rotation matrix U into the new reference frame.

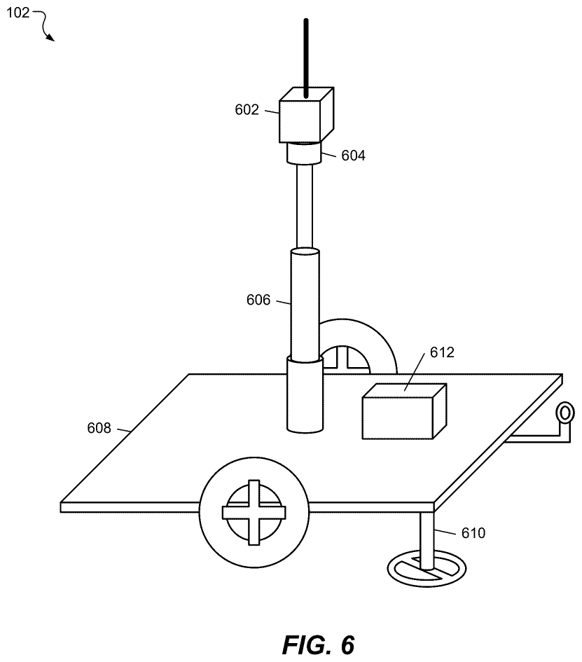

FIG. 6 is an isometric view illustrating an example of a reference magnetic sensor system 102, according to some embodiments. The reference magnetic sensor system 102 may include a sensor unit 602. The sensor unit 602 may measure the magnetic field's strength and/or direction. The sensor unit 602 may be any of the previously described magnetic sensors. The sensor unit 602 may be coupled to a positioning unit 604. The positioning unit 604 may level and adjust the orientation of the sensor unit 602 along three axes (e.g., pitch, roll, and yaw) to align the sensor unit 602. The positioning unit 604 may be coupled to a lifting unit 606. The lifting unit may adjust the height of the sensor unit 602, allowing the sensor unit 602 to be positioned at different elevations. The lifting unit 606 may be coupled to a mobile platform 608. The mobile platform 608 may allow the reference magnetic sensor system 102 to be transported and positioned at various locations. A ground stabilization unit 610 may be coupled to the mobile platform 608 to ensure that the mobile platform 608 remains stable and level with the ground, even if the ground is uneven.

The reference magnetic sensor system 102 may include a power and support electronics unit 612. The power and support electronics unit 612 may include the power supply and additional electronic components necessary to operate sensor unit 602, the positioning unit 604, and/or the lifting unit 606. The sensor unit 602 may include sensors for determining geographic north. For example, the sensor unit 602 may include GPS receivers, optical gyroscopes (such as Sagnac effect-based gyroscopes), fiber optic gyroscopes (FOG), ring laser gyroscopes (RLG), vibration structure gyroscopes (such as Coriolis gyroscopes), and/or microelectromechanical systems (MEMS).

The sensor signal processing application 118 and/or the sensor unit 602 may use GPS sensors to determine the orientation of the sensor unit 602 relative to geographic north using a GPS-based heading determination technique. For example, two or more GPS sensors may be positioned at known distances between each other. In some examples, one of the GPS sensors may be attached to the sensor unit 602, and a second one of the GPS sensors can be positioned a known distance away. The sensor signal processing application 118 and/or the power and support electronics unit 612 can utilize the GPS positions to calculate the orientation of the system. This orientation can be used in conjunction with the relative alignment of the sensor unit 602 to obtain geographic north.

The sensor signal processing application 118 and/or the power and support electronics unit 612 may align the above-described gyroscopes to a known reference direction. The gyroscopes may be attached to the sensor unit 602. When the sensor unit 602 is stationary relative to the Earth's surface, the gyroscope primarily detects the Earth's rotation thereby determining geographic north. However, when the sensor unit 602 changes its orientation, the gyroscope measures the angular velocity of the sensor unit 602 in addition to the Earth's rotation. The sensor signal processing application 118 and/or the power and support electronics unit 612 may integrate the angular velocity over time to determine orientation changes of the sensor unit 602. The sensor signal processing application 118 and/or the power and support electronics unit 612 may adjust the orientation of the sensor unit 602 to align with geographic north based on data from the gyroscopes.

In some examples, the sensor unit 602 may be aligned to geographic north by referencing pre-surveyed physical markers. For example, a first geographic point and a second geographic point may be surveyed such that the vector from the second geographic point to the first geographic point defines geographic north. A marker (such as a reference tower) may be positioned at the first geographic point and the sensor unit 602 may be positioned at the second geographic point. The sensor unit 602 may then be aligned to face the marker. While three exemplary methods for aligning the sensor unit 602 with geographic north are described in detail above, other appropriate methods may be used, for example, depending on the specific application and/or environmental conditions.

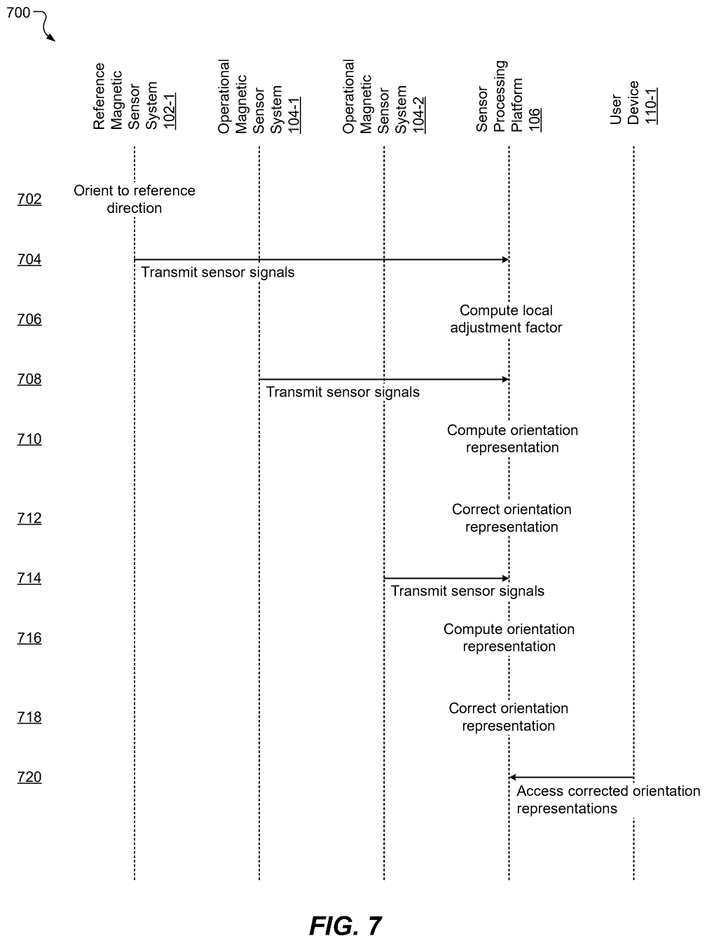

FIG. 7 is a message sequence chart 700 illustrating example interactions between components of the magnetic sensor system 100, according to some embodiments. In FIG. 7, the sensor processing platform 106 is shown as a distinct element from the operational magnetic sensor systems 104. However, as previously described, in some implementations, a sensor processing platform 106 may be integrated with each operational magnetic sensor system 104. Thus, in some examples, the various processing steps illustrated as being performed by the sensor processing platform 106 are instead performed by a respective sensor processing platform 106 integrated with each operational magnetic sensor system 104. For example, sensor processing platform 106-1 may be integrated with operational magnetic sensor system 104-1, and sensor processing platform 106-2 may be integrated with operational magnetic sensor system 104-2, facilitating local processing at each operational magnetic sensor system 104.

In the message sequence chart 700, reference magnetic sensor system 102-1 may be oriented to a reference direction (at operation 702). The reference direction may be geographic north. The reference magnetic sensor system 102-1 may also be oriented so that it is level with the horizon (e.g., parallel to the ground or horizontal plane). In the message sequence chart 700, while aligned, the reference magnetic sensor system 102-1 may transmit sensor signals indicative of magnetic field readings to the sensor processing platform 106 via the communications system 108 (at operation 704). In some examples, rather than transmitting complete magnetic field readings, the reference magnetic sensor system 102-1 transmits a differential value representing the change between a previous magnetic field reading and a current magnetic field reading. The sensor processing platform 106 then computes the current magnetic field reading by applying the transmitted differential to the previously computed magnetic field reading. In the message sequence chart 700, at the sensor processing platform 106, the sensor signal processing application 118 may compute local adjustment factors based on the sensor signals from the reference magnetic sensor system 102-1 (at operation 706). The local adjustment factor may include a local declination representation (e.g., a declination angle, vector, and/or quaternion) and/or a local inclination representation (e.g., an inclination angle, vector, and/or quaternion) and/or magnetic field magnitude and/or a vector representation of the measurement to allow for discrimination between area wide disturbances and those encountered near one of the operational magnetic sensor systems 104.

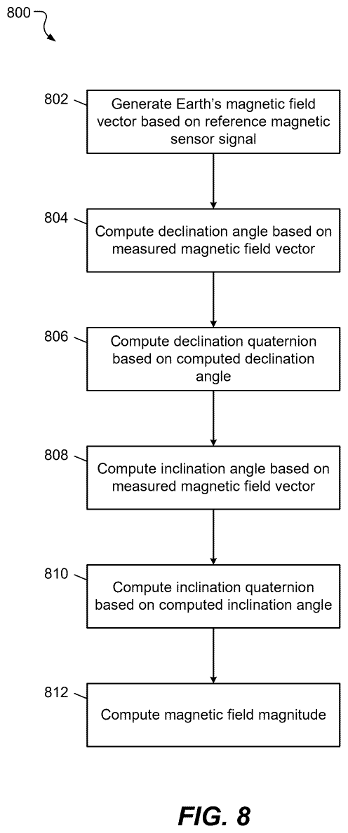

FIG. 8 is a flowchart illustrating an example process 800 for computing local adjustment factors based on sensor signals from the reference magnetic sensor system 102-1, according to some embodiments. In various implementations, one or more of the local adjustment factors computed at operation 706 may be computed according to the example process 800. In the example process 800, the sensor signal processing application 118 generates a magnetic field vector M based on the sensor signals from the reference magnetic sensor system 102-1 (at block 802). For example, the magnetic field vector M may be computed according to Equation (20) below:

$$M = ( {M}_{x} , {M}_{y} , {M}_{z} ) \qquad ( 20 )$$

The magnetic field vector M may include three components (Mₓ, M_{y}, M_{z}) representing the Earth's magnetic field strength in the coordinate system of the reference magnetic sensor system 102-1. In the example process 800, the sensor signal processing application 118 computes a magnetic declination angle DA based on the magnetic field angle M (at block 804). Since the declination angle DA is the angle between magnetic north and geographic north, the declination angle DA may be computed as the angle between the x and y components of the magnetic field vector (Mₓ and M_{y}, respectively). The declination angle DA may be computed according to Equation (21) below:

$$DA = a tan 2 ( {M}_{y} , {M}_{x} ) \qquad ( 21 )$$

In the example process 800, the sensor signal processing application 118 computes a declination quaternion qDA based on the computed declination angle DA (at block 806). A quaternion q extends the complex number system to four dimensions and may be used to represent orientations and/or rotations in three-dimensional. Representing orientations and/or rotations using quaternions q may provide a variety of technical benefits, particularly for computer technologies. For example, quaternions require only four values to represent a rotation, while rotation matrices require nine values. Thus, quaternions may be more memory-efficient than rotation matrices.

Quaternions also allow for smooth and efficient interpolation between rotations, making them particularly suitable for smoothly representing movements on graphical user interfaces. Furthermore, quaternions avoid the gimbal lock problem that can occur with Euler angles, ensuring that all three axes of rotation are always available. Quaternions may also be more numerically stable than rotational matrices, as they may be less prone to errors and drift due to rounding and the associated accumulation of small errors during computation. Additionally, quaternion operations may be more computationally efficient/lightweight than matrix operations, especially for small rotations.

Since the declination angle DA may be computed as an angle in the x-y plane, the declination angle quaternion qDA may be represented as a rotation about the z-axis. For a rotation around an angle θ around a unit vector u=(uₓ, u_{y}, u_{z}), the quaternion q may be expressed according to Equation (22) below:

$$q = ( cos ( \frac{θ}{2} ) , {u}_{x} sin ( \frac{θ}{2} ) , {u}_{y} sin ( \frac{θ}{2} ) , {u}_{z} sin ( \frac{θ}{2} ) ) \qquad ( 22 )$$

For a rotation about the z-axis, the axis of rotation is along the unit vector u defining the z-axis. The unit vector u may be expressed according to Equation (23) below:

$$u = ( 0 , 0 , 1 ) \qquad ( 23 )$$

Thus, the declination quaternion qDA, in an East-North-Up (ENU) coordinate system, representing the declination angle DA may be expressed according to Equation (24) below:

$$qDA = ( cos ( \frac{DA}{2} ) , 0 , 0 , sin ( \frac{DA}{2} ) ) \qquad ( 24 )$$

In the example process 800, the sensor signal processing application 118 computes an inclination angle IA based on the magnetic field vector M (at block 808). The inclination angle IA may be the angle between the Earth's magnetic field vector M and the horizontal plane. Thus, the inclination angle IA may be expressed as a function of the components of the magnetic field vector M according to Equation (25) below:

$$IA = a tan ( \frac{{M}_{z}}{\sqrt{{{M}_{x}}^{2} + {{M}_{y}}^{2}}} ) \qquad ( 25 )$$

In the example process 800, the sensor signal processing application 118 computes an inclination angle quaternion qIA based on the computed inclination angle IA (at block 810). As previously described, representing the inclination angle IA as an inclination angle quaternion qIA may provide a variety of technical benefits for computing technologies. Since the inclination angle IA may be computed as an angle in the x-z plane, the inclination angle quaternion qIA may be represented as a rotation about the y-axis. For a rotation about the y-axis, the axis of rotation is along the unit vector u defining the x-axis in ENU, which may be expressed according to Equation (26) below:

$$u = ( 1 , 0 , 0 ) \qquad ( 26 )$$

Thus, the inclination quaternion qIA representing the inclination angle IA may be expressed according to Equation (27) below:

$$qIA = ( cos ( \frac{IA}{2} ) , sin ( \frac{IA}{2} ) , 0 , 0 ) \qquad ( 27 )$$

In the example process 800, the sensor signal processing application computes a magnetic field vector based on components of the magnetic field vector M (at block 812). The magnetic field magnitude |M| may be computed as the Euclidean norm of the magnetic field vector M. The magnetic field magnitude |M| may represent the total strength of the magnetic field at the sensor unit 602, and may be computed according to Equation (28) below:

$$\vert M \vert = \sqrt{{{M}_{x}}^{2} + {{M}_{y}}^{2} + {{M}_{z}}^{2}} \qquad ( 28 )$$

The computed magnetic field magnitude |M| may provide a scalar value representing the strength of the Earth's magnetic field at the sensor unit 602, which may be used for determining local magnetic anomalies and/or for calibrating operational magnetic sensor systems to correct for any deviations from the expected magnetic field strength.

Returning to FIG. 7, in the message sequence chart 700, the operational magnetic sensor system 104-1 may transmit sensor signals indicative of magnetic field readings to the sensor processing platform 106 (at operation 708). In the message sequence chart 700, at the sensor processing platform 106, the sensor signal processing application 118 may compute an orientation representation for the operational magnetic sensor system 104-1 (at operation 710). The orientation representation may include the magnetic heading (or azimuth) and/or magnetic elevation (or pitch) of the operational magnetic sensor system 104-1. For example, the orientation representation may include a separate magnetic heading angle, vector, and/or quaternion and a separate magnetic elevation angle, vector, and/or quaternion, or a combined magnetic orientation angle, vector, and/or quaternion (representing both heading and elevation). In various implementations, the orientation representation includes a magnitude of the magnetic field (for example, computed according to any of the previously described methods).

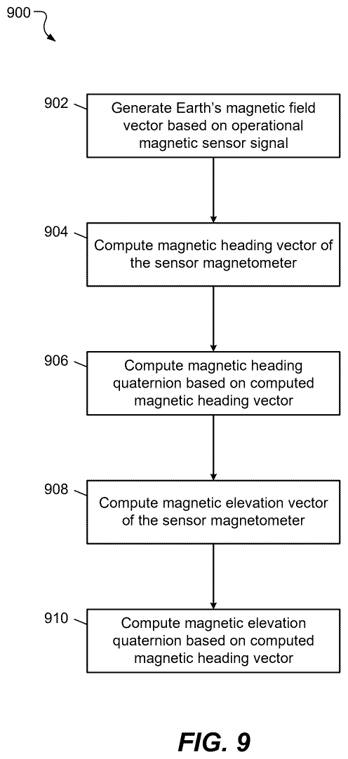

FIG. 9 illustrates an example process 900 for computing magnetic orientation representations. One or more of the magnetic orientation representations computed at operation 710 may be computed according to the example process 900. In the example process 902, the sensor signal processing application 118 generates a magnetic field vector B based on sensor signals from the operational magnetic sensor system 104-1 (at block 902). The magnetic field vector B may be expressed according to Equation (29) below:

$$B = ( {B}_{x} , {B}_{y} , {B}_{z} ) \qquad ( 29 )$$

The magnetic field vector B may include three components (Bₓ, B_{y}, B_{z}) representing the Earth's magnetic field strength in the coordinate system of the operational magnetic sensor system 104-1. In some examples, (Bₓ, B_{y}, B_{z}) can be normalized so that B is a unit vector.

In the example process 900, the sensor signal processing application 118 computes a magnetic heading vector GE based on the magnetic field vector B (at block 904). The magnetic heading angle GE may be computed according to Equation (30) below:

$$GE = a tan 2 ( {B}_{y} , {B}_{x} ) \qquad ( 30 )$$

In the example process 900, the sensor signal processing application 118 computes a magnetic heading quaternion qGE based on the computed magnetic heading angle GE (at block 906). As previously described, since the magnetic heading vector GE may represent a rotation about the z-axis. The magnetic heading quaternion qGE may be expressed according to Equation (31) below:

$$qGE = ( cos ( \frac{GE}{2} ) , 0 , 0 , sin ( \frac{GE}{2} ) ) \qquad ( 31 )$$

In the example process 900, the sensor signal processing application 118 computes a magnetic elevation angle ME based on the magnetic field vector B (art block 908). For example, the magnetic elevation angle ME may be computed according to Equation (32) below:

$$ME = a tan ( \frac{- {B}_{z}}{\sqrt{{B}_{x}^{2} + {B}_{y}^{2}}} ) \qquad ( 32 )$$

In the example process 900, the sensor signal processing application 118 computes a magnetic elevation quaternion qME based on the computed magnetic elevation vector ME (at block 910). As previously described, since the magnetic elevation angle ME may represent a rotation about the x-axis, the magnetic elevation quaternion qME may be expressed as:

$$qME = ( cos ( \frac{ME}{2} ) , sin ( \frac{ME}{2} ) , 0 , 0 ) \qquad ( 33 )$$

In practice, the inclination angle, ME, may not be the angle used as a correction. That is, an angle representing the difference between a starting value and a change as a result of an update from the reference magnetic system 102 may be used. The quaternion of the angle representing the difference qΔME may be expressed according to Equation (34) below:

$$q Δ ME = ( cos ( \frac{Δ ME}{2} ) , sin ( \frac{Δ ME}{2} ) , 0 , 0 ) \qquad ( 34 )$$

In some examples, the sensor signal processing application 118 combines the magnetic heading quaternion qGE and the magnetic elevation quaternion qME to generate a combined magnetic heading and elevation quaternion qHE, which may be expressed according to Equation (35) below:

$$qHE = qGE ⊗ q Δ ME \qquad ( 35 )$$

Returning to FIG. 7, in the message sequence chart 700, the sensor signal processing application 118 may correct the orientation representation (e.g., the magnetic heading quaternion qGE, the magnetic elevation quaternion qΔME, the combined heading and elevation quaternion qHE, and/or the magnetic field magnitude, etc.) for the operational magnetic sensor system 104-1 using the local adjustment factor (e.g., the declination quaternation qDA and/or the inclination quaternion qIA and/or other corrections such as the magnetic field magnitudes at the reference magnetic sensor systems 102, etc.) (at operation 712). In some examples, the sensor signal processing application 118 corrects the magnetic heading quaternion qGE using the declination quaternion qDA to generate a corrected heading quaternion qTN, for example, according to Equation (36) below:

$$qTN = qDA ⊗ qGE \qquad ( 36 )$$

In some examples, the sensor signal processing application 118 corrects the magnetic elevation quaternion qME using the inclination quaternion qIA to generate a corrected elevation quaternion qTE, for example, according to Equation (37) below:

$$qTE = qIA ⊗ q Δ ME \qquad ( 37 )$$

In some examples, the sensor signal processing application 118 generates a corrected combined quaternion qCC based on the corrected heading quaternion qTN and the corrected elevation quaternion qΔME, for example, according to Equation (38) below:

$$qCC = qDA ⊗ q Δ ME ⊗ qGE \qquad ( 38 )$$

In some examples, the sensor signal processing application 118 generates the corrected combined quaternion qCC by applying more than rotations. This may be due to the fact that deviations in the magnetic field may be accompanied by changes to the strength of the field.

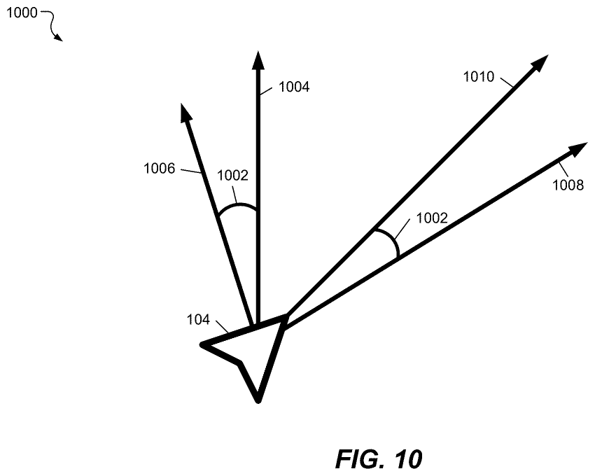

FIG. 10 is a schematic illustration 1000 of relationships between local adjustment factors and magnetic orientations, according to some embodiments. As illustrated in FIG. 10, the local adjustment factor 1002 may represent a correction needed to align magnetic north 1004 with geographic north 1006. Applying the local adjustment factor 1002 to the magnetic orientation representation 1008 generated based on sensor signals from the operational magnetic sensor system 104 corrects the magnetic orientation representation 1008 to a corrected representation 1010 (e.g., a representation of the true heading and/or true elevation of the operational magnetic sensor system 104).

Returning to FIG. 7, in the message sequence chart 700, the operational magnetic sensor system 104-2 may transmit sensor signals indicative of magnetic field readings to the sensor processing platform 106 (at operation 714). In the message sequence chart 700, at the sensor processing platform 106, the sensor signal processing application 118 may compute an orientation representation for the operational magnetic sensor system 104-2 (for example, according to any of the previously described techniques) (at operation 716). In the message sequence chart 700, the sensor signal processing application 118 may correct the orientation representation for the operational magnetic sensor system 104-2 using the local adjustment factor (for example, according to any of the previously described techniques) (at operation 718).

In the message sequence chart 700, the user device 110-1 may access the corrected orientation representations (at operation 720). For example, the magnetic vector orientation application 120 may send the corrected orientation representations to the user device 110-1 via the communications system 108, and the user device 110-1 may display the corrected orientation representations on a graphical user interface. In some examples, the magnetic vector orientation application 120 generates the graphical user interface, and the user device 110-1 accesses the generated graphical user interface via the communications system 108. Additionally or alternatively, in some implementations, the user device 110-1 may perform any of the computing operations described in the message sequence chart 700 as being performed by the sensor processing platform 106.

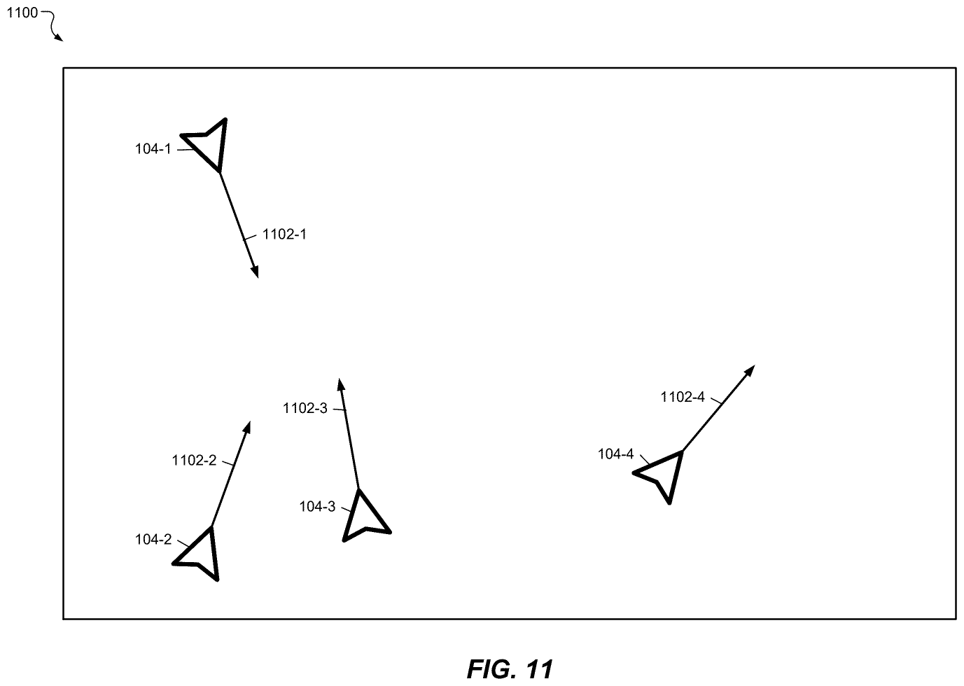

FIG. 11 illustrates an example graphical user interface 1100 generated by the magnetic vector orientation application 120 and/or the user device 110, according to some embodiments. The graphical user interface 1100 may depict a representation of the environment around the operational magnetic sensor systems 104, and each operational magnetic sensor system 104 may be positioned at a location corresponding with its real-world location (e.g., as determined using a position sensor associated with each operational magnetic sensor system 104). An orientation 1102 of each operational magnetic sensor system 104 may be generated based on the respective corrected representation 1010. Although FIG. 11 illustrates a two-dimensional depiction, the environment, operational magnetic sensor systems 104, and/or orientations 1102 may be rendered in three dimensions.

As previously described, generating corrected representations 1010 as quaternions may provide computational efficiencies for the magnetic vector orientation application 120 and/or the user device 110, particularly in examples where the graphical user interface 1100 is rendered in three dimensions. For example, quaternions do not suffer from gimbal lock, a problem that results from the axes of a rotation system becoming aligned, which may cause a loss of a degree of freedom. Generating corrected representations 1010 may allow the orientation 1102 to smoothly and continuously rotate without causing discontinuities.

Furthermore, quaternions require only four components (one scalar and three vector components) compared to rotation matrices (which require nine components). This compact representation reduces the amount of data processed and transmitted by the rendering engine. Quaternion operations (such as quaternion multiplication) may be computationally less expensive than equivalent matrix operations. This may result in faster calculations when interpolating between orientations. Additionally, quaternions may allow for smoother interpolation between rotations (e.g., using techniques such as spherical linear interpolation [SLERP]). This may facilitate smoother animations and real-time updates at the rendering engine. Furthermore, quaternions avoid accumulated rounding errors and maintain stability over multiple transformations, helping ensure the stability and precision of the orientations 1102 over multiple movements.

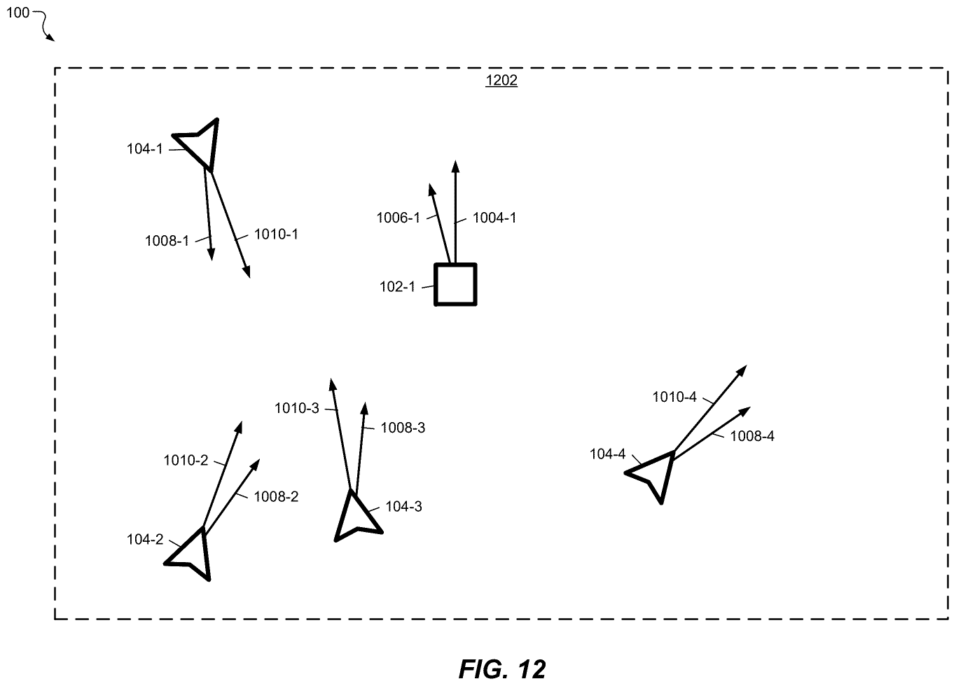

FIG. 12 is a block diagram illustrating an exemplary deployment of the system 100, according to some embodiments. FIG. 12 shows that the system 100 may be implemented with a single reference magnetic sensor system 102-1 and one or more operational magnetic sensor systems 104 (such as operational magnetic sensor systems 104-1-104-4) deployed to an operational area 1202. The sensor signal processing application 118 may compute a local adjustment factor based on sensor signals from the single reference magnetic sensor system 102-1 and apply the local adjustment factor to all operational magnetic sensor systems 104 deployed to the operational area 1202.

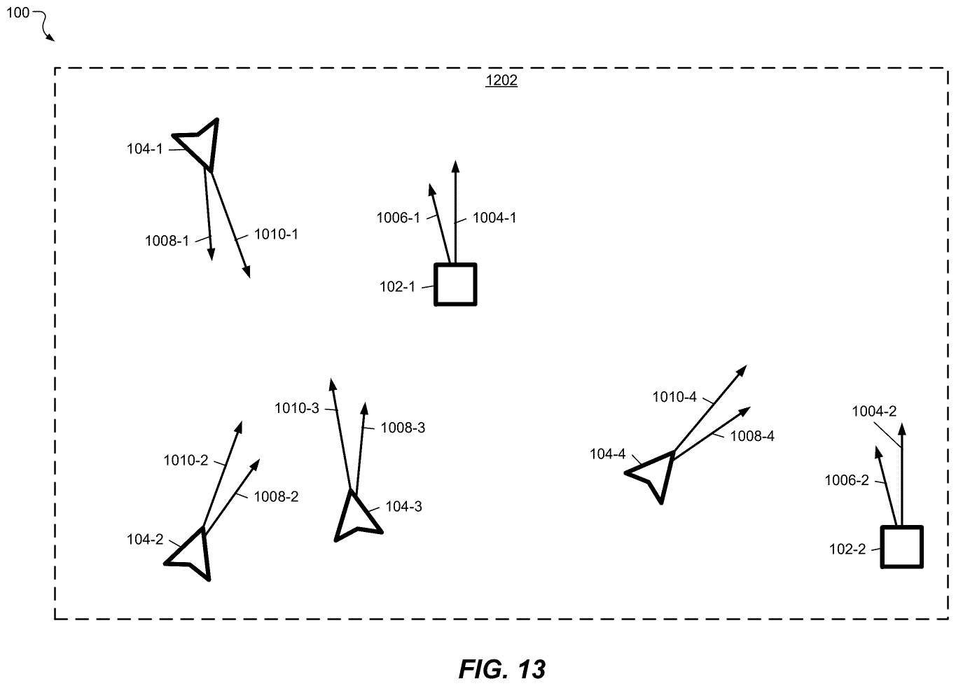

FIG. 13 is a block diagram illustrating an exemplary deployment of the system 100, according to some embodiments. FIG. 13 shows that the system 100 may be implemented with multiple reference magnetic sensor systems 102 (such as reference magnetic sensor systems 102-1 and 102-2) deployed across the operational area 1202. The sensor signal processing application 118 may compute a local adjustment factor based on sensor signals from each reference magnetic sensor system 102. The sensor signal processing application 118 may determine and/or track a location of each reference magnetic sensor system 102 and each operational magnetic sensor system 104 and apply the local adjustment factor generated from sensor signals of the nearest reference magnetic sensor system 102 to each respective operational magnetic sensor system 104.

For example, since the operational magnetic sensor systems 104-1-104-3 are closer to the reference magnetic sensor system 102-1 than the reference magnetic sensor system 102-2, the sensor signal processing application 118 applies the local adjustment factor generated from the sensor signal of the reference magnetic sensor system 102-1 to correct the magnetic orientation representations of the operational magnetic sensor systems 104-1-104-3. Similarly, since the operational magnetic sensor system 104-4 is closer to the reference magnetic sensor system 102-2 than the reference magnetic sensor system 102-1, the sensor signal processing application 118 applies the local adjustment factor generated from the sensor signal of the reference magnetic sensor system 102-2 to correct the magnetic orientation representation of the operational magnetic sensor system 104-4.

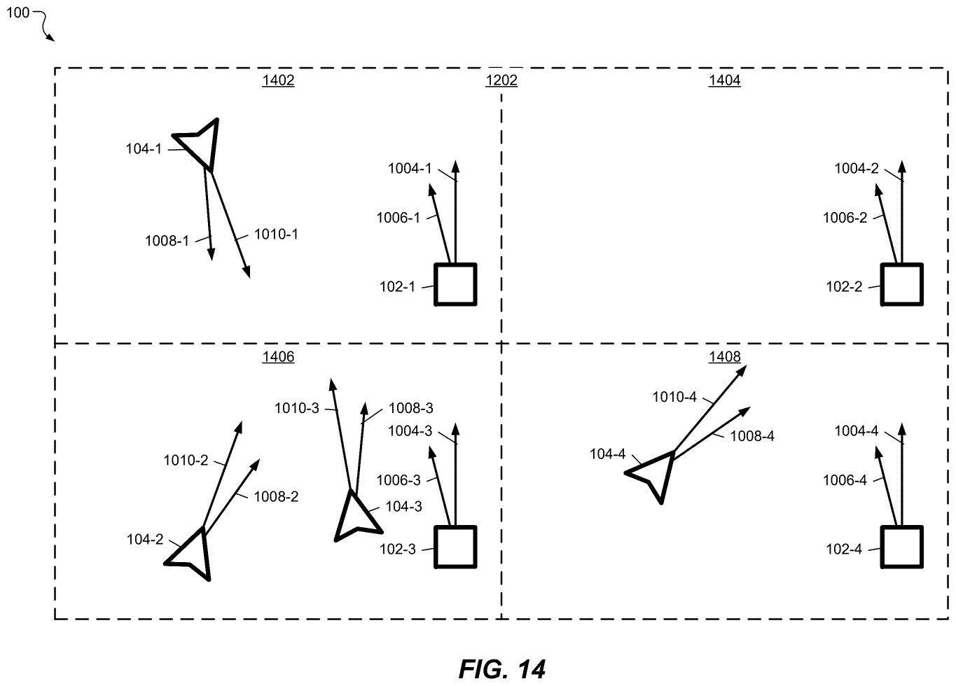

FIG. 14 is a block diagram illustrating an exemplary deployment of the system 100, according to some embodiments. FIG. 14 shows that the operational area 1202 may be further subdivided into operational areas 1402-1408, and a reference magnetic sensor system 102 may be deployed to each of the operational areas 1402-1408 (e.g., reference magnetic sensor systems 102-1-102-4, respectively) to generate a local adjustment factor for the operational magnetic sensor systems 104 deployed to each respective operational area.

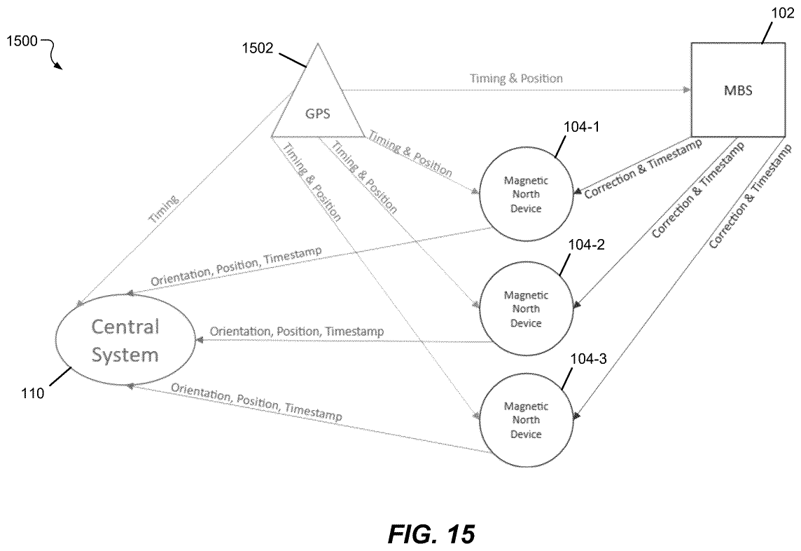

FIG. 15 is a block diagram 1500 illustrating data flows between components of the system 100, according to some embodiments. In the example of FIG. 15, the reference magnetic sensor system 102 may be implemented with the functionality of the sensor processing platform 106. The reference magnetic sensor system 102 may receive timing and position data from a global positioning system (GPS) 1502. The operational magnetic sensor systems 104-1, 104-2, and/or 104-3 may receive timing and position data from the GPS 1502. The reference magnetic sensor system 102 may generate corrections (such as local adjustment factors) according to any of the previously described techniques. The reference magnetic sensor system 102 may transmit the corrections and timestamps to the operational magnetic sensor systems 104-1, 104-2, and/or 104-3.

The operational magnetic sensor systems 104-1, 104-2, and/or 104-3 may apply the correction received from the reference magnetic sensor system 102 to generate an orientation, and transmit the orientation, a position of each respective operational magnetic sensor system 104, and a timestamp to the user devices 110. The user devices 110 may also receive timing information from the GPS 1502. Thus, the components of the system 100 may provide time-synchronization between the corrections generated by the reference magnetic sensor system 102 and the magnetic orientations (e.g., to be corrected) generated by the operational magnetic sensor systems 104, and/or the orientations and/or positions transmitted from each operational magnetic sensor system 104 to the user devices 110.

In some implementations, the functionality of the sensor processing platform 106 is instead implemented locally at each respective operational magnetic sensor system 104. In such configurations, each operational magnetic sensor system 104-1, 104-2, and/or 104-3 may receive sensor signals from the reference magnetic sensor system 102. Each operational magnetic sensor system 104 may then compute and apply the local adjustment factors locally to its own sensor signals, as previously described. This “edge” deployment architecture allows each operational magnetic sensor system 104 to perform the necessary computations locally without relying on centralized processing. Facilitating localized computation may reduce latency in the system 100, improve responsiveness at the operational magnetic sensor systems 104.

Various implementations of the system 100 can provide technical benefits across a range of practical applications (in addition to the previously described practical applications). For example, the system 100 may be used to correct changes in the heading (yaw) of a magnetic sensor relative to the initial magnetic field reading of the magnetic sensor. The system 100 may accomplish this without requiring knowledge of the relationship between geographic north and magnetic north. While the system 100 may be capable of supporting various timing methods, a GPS 1502 may be used to ensure consistent timing across the components of the system 100. The reference magnetic sensor systems 102 may include magnetometers that match or exceed the performance of magnetometers in the operational magnetic sensor systems 104 to reduce or eliminate noise. This noise reduction or elimination can be achieved through an appropriate combination of hardware (ensuring high accuracy and precision in measurement) and software (which may implement techniques for smoothing the measurements).

The initial magnetic field measurement from the reference magnetic sensor system 102 (or a combination of initial measurements) may be used to compute an initial angle, which can be stored and timestamped. The magnetic field may be measured at a regular rate, and a new angle can be computed. The difference between the initial angle and the new angle may be transmitted to the operational magnetic sensor systems 104 and/or the sensor processing platform 106, where it can be used to apply a correction to the orientation of the operational magnetic sensor systems 104 using a raw rotation (for example, as previously described with reference to Equation (4)). Both the change in angle and the original angle may be computed in a navigation frame, which may be the reference frame of the reference magnetic sensor system 102. Since the operational magnetic sensor systems 104 may rotate relative to the navigation frame, the yaw correction may be applied after the vectors of the reference frames of the operational magnetic sensor systems 104 have been rotated into the navigation frame.

Mathematically, this may be expressed according to Equation (39) below, where U is the rotation matrix that transforms vectors vₛ from the reference frame of the operational magnetic sensor system 104 to vectors vₙ of the navigation frame:

$${v}_{n} = {Uv}_{s} \qquad ( 39 )$$

The reference magnetic sensor system 102 and/or the sensor processing platform 106 may compute a yaw matrix D that corrects for changes in the magnetic field, which may be applied to the vectors vₛ from the reference frame of the operational magnetic sensor system 104 according to Equation (40) below:

$${v}_{n} = {DUv}_{s} \qquad ( 40 )$$

In other examples, the system 100 may be used to maintain a consistent geographic north-based heading. Such examples may be particularly useful for locally distributed systems of operational magnetic sensor systems 104 that operate with magnetic north as their primary reference but benefit from alignment with geographic north for greater accuracy. Such examples may be similar to the preceding examples that implement yaw correction but include a few differences. For example, it may be necessary to first ascertain the geographic north direction relative to the reference magnetic sensor system 102. Furthermore, the yaw correction angle may need to be adjusted to account for the declination angle.

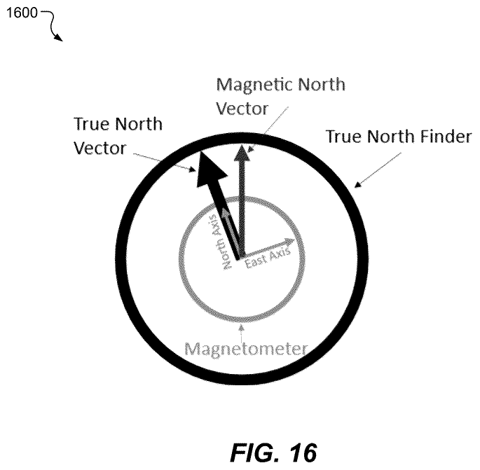

In such examples, the axes of the north finder and the reference magnetic sensor system 102 may need to be aligned, with the north axis of the north finder pointing directly towards geographic north. Thus, the geographic north finder may be used to align the north axis of the reference magnetic sensor system 102 with geographic north. FIG. 16 is a schematic diagram 1600 illustrating the alignment of the north axis of a reference magnetic sensor system 102 with geographic north indicated by a geographic north finder, according to some embodiments.

After the north axis of the reference magnetic sensor system 102 is aligned with geographic north, the declination angle may be computed which, when applied, may yield the necessary angle for correcting magnetic headings indicated by operational magnetic sensor systems 104. The yaw correction may be applied (as previously described), but with the declination angle factored in, which may ensure that the headings of the operational magnetic sensor systems 104 are accurately adjusted relative to geographic north.

In other examples, the system 100 may be implemented to account for temporal changes in a geomagnetic field across an area. Temporal changes may not be limited to simple rotations. Instead, such changes can affect the declination angle, inclination angle, and/or the overall magnitude of the magnetic field strength. Moreover, sensor systems disturbed across wide areas may encounter local disturbances, such as those caused by ferrous objects like vehicles or power lines, which may further complicate the task of maintaining accurate orientation.

In such examples, the reference magnetic sensor systems 102 may provide comprehensive three-dimensional magnetic field measurements. These measurements may be used to not only detect anomalies but also to distinguish between geomagnetic field changes and local disturbances. Additionally, because the magnetic field data of the reference magnetic sensor system 102 may be oriented with respect to geographic north, the measurements may also include the necessary information for reorienting the operational magnetic sensor systems 104 from magnetic north to geographic north.

Some example methodologies for achieving anomaly detection and geographic north correction follow. Anomaly detection may be performed by computing the magnitude of the magnetic vector received from the reference magnetic sensor system 102. The declination angle of the magnetic vector received from the reference magnetic sensor system 102 may be computed. The inclination angle [symbol] of the magnetic vector received from the reference magnetic sensor system 102 may be computed according to Equation (41) below:

$${∡}_{inc} = a tan ( \frac{{m}_{U}}{\sqrt{{m}_{E}^{2} + {m}_{N}^{2}}} ) \qquad ( 41 )$$

The magnitude, declination angle, and/or inclination angle may be compared with the measurements from the operational magnetic sensor systems 104 and used to correct measurements from the operational magnetic sensor systems 104.

After anomaly detection, the orientations of the operational magnetic sensor system 104 may be corrected from magnetic north to geographic north. For example, the declination angle and/or inclination angle may be used to compute an equivalent magnetic north vector for the operational magnetic sensor system 104 using, for example, a matrix- or quaternion-based rotation. The difference between the geographic north vector and the magnetic north vector may be determined and denoted as

$${Δ}_{TM}^{Nav} .$$

The current orientation transformation matrix U may be used to transform the difference vector back to the sensor frame as

$${Δ}_{TM}^{Sen} ,$$

which may be computed according to Equation (42) below:

$${Δ}_{TM}^{Sen} = {U}^{- 1} {Δ}_{TM}^{Nav} \qquad {Δ}_{TM}^{Sen}$$

This difference vector

$${Δ}_{TM}^{Sen}$$

may be applied to sensor readings from the operational magnetic sensor system 104 to find the geographic north magnetic vector in the sensor frame and/or compute an updated transformation matrix U.

The foregoing description is merely illustrative in nature and does not limit the scope of the disclosure or its applications. The broad teachings of the disclosure may be implemented in many different ways. While the disclosure includes some particular examples, other modifications will become apparent upon a study of the drawings, the text of this specification, and the following claims. In the written description and the claims, one or more processes within any given method may be executed in a different order—or processes may be executed concurrently or in combination with each other—without altering the principles of this disclosure. Similarly, instructions stored in a non-transitory computer-readable medium may be executed in a different order—or concurrently—without altering the principles of this disclosure. Unless otherwise indicated, the numbering or other labeling of instructions or method steps is done for convenient reference and does not necessarily indicate a fixed sequencing or ordering.

It should also be noted that a plurality of hardware and software-based devices, as well as a plurality of different structural components may be utilized in various implementations. Aspects, features, and instances may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one instance, the electronic based aspects of the invention may be implemented in software (for example, stored on non-transitory computer-readable medium) executable by one or more processors. As a consequence, it should be noted that a plurality of hardware and software-based devices, as well as a plurality of different structural components may be utilized to implement the invention. For example, “control units” and “controllers” described in the specification can include one or more electronic processors, one or more memories including a non-transitory computer-readable medium, one or more input/output interfaces, and various connections (for example, a system bus) connecting the components.

Unless the context of their usage unambiguously indicates otherwise, the articles “a,” “an,” and “the” should not be interpreted to mean “only one.” Rather, these articles should be interpreted to mean “at least one” or “one or more.” Likewise, when the terms “the” or “said” are used to refer to a noun previously introduced by the indefinite article “a” or “an,” the terms “the” or “said” should similarly be interpreted to mean “at least one” or “one or more” unless the context of their usage unambiguously indicates otherwise.

It I should also be understood that although certain drawings illustrate hardware and software located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable connections or links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations collectively. To reiterate, those electronic processors and processing may be distributed.

Spatial and functional relationships between elements—such as modules—are described using terms such as (but not limited to) “connected,” “engaged,” “interfaced,” and/or “coupled.” Unless explicitly described as being “direct,” relationships between elements may be direct or include intervening elements. The phrase “at least one of A, B, and C” should be construed to indicate a logical relationship (A OR B OR C), where OR is a non-exclusive logical OR, and should not be construed to mean “at least one of A, at least one of B, and at least one of C.” The term “set” does not necessarily exclude the empty set. For example, the term “set” may have zero elements. The term “subset” does not necessarily require a proper subset. For example, a “subset” of set A may be coextensive with set A, or include elements of set A. Furthermore, the term “subset” does not necessarily exclude the empty set.

In the figures, the directions of arrows generally demonstrate the flow of information—such as data or instructions. The direction of an arrow does not imply that information is not being transmitted in the reverse direction. For example, when information is sent from a first element to a second element, the arrow may point from the first element to the second element. However, the second element may send requests for data to the first element, and/or acknowledgements of receipt of information to the first element. Furthermore, while the figures illustrate a number of components and/or steps, any one or more of the components and/or steps may be omitted or duplicated, as suitable for the application and setting.

Additionally, operations (such as processes, decisions, inputs, outputs, actions, messages, interactions, events, and/or any other operations) shown in the flowcharts and/or message sequence charts may be illustrated once each and in a particular order in the drawings. However, in various implementations, the operations may be reordered and/or repeated as may be suitable. In some examples, different operations may be performed in parallel, as may be appropriate.

The term computer-readable medium does not encompass transitory electrical or electromagnetic signals or electromagnetic signals propagating through a medium-such as on an electromagnetic carrier wave. The term “computer-readable medium” is considered tangible and non-transitory. The functional blocks, flowchart elements, and message sequence charts described above serve as software specifications that can be translated into computer programs by the routine work of a skilled technician or programmer.

What is claimed is:

1. A system comprising:
a reference magnetic sensor configured to detect components of a magnetic field at a first location and generate reference sensor signals;
non-transitory computer-readable storage media storing instructions; and
at least one electronic processor configured to execute the instructions to:
receive the reference sensor signals from the reference magnetic sensor;
compute a local adjustment factor based on the reference sensor signals;
receive operational sensor signals from an operational magnetic sensor configured to detect components of the magnetic field at a second location;
compute an orientation representation based on the operational sensor signals; and
apply the local adjustment factor to the orientation representation to generate a corrected orientation representation.

2. The system of claim 1, wherein the at least one electronic processor is further configured to track a location of an object based on the corrected orientation representation.

3. The system of claim 1, wherein the at least one electronic processor is further configured to transmit the corrected orientation representation to a computing system configured to track a location of an object based on the corrected orientation representation.

4. The system of claim 1, wherein the local adjustment factor includes a magnetic declination quaternion.

5. The system of claim 1, wherein the local adjustment factor includes a magnetic inclination quaternion.

6. The system of claim 1, wherein the orientation representation includes a magnetic heading quaternion.

7. The system of claim 1, wherein the orientation representation includes a magnetic declination quaternion.

8. The system of claim 1, wherein the corrected orientation representation includes a corrected quaternion and the corrected quaternion represents a three-dimensional orientation of the operational magnetic sensor.

9. The system of claim 1, wherein the local adjustment factor includes a magnetic field magnitude and the corrected orientation representation includes a corrected magnetic field magnitude.

10. The system of claim 1, wherein the at least one electronic processor is further configured to render a graphical representation according to the corrected orientation representation on a graphical user interface, the graphical representation depicting a three-dimensional orientation of the operational magnetic sensor.

11. The system of claim 1, wherein:
the operational magnetic sensor includes a plurality of operational magnetic sensors distributed over a geographical area; and
the local adjustment factor includes a plurality of local adjustment factors.

12. A method comprising:
receiving, at a sensor processing platform, reference sensor signals from a reference magnetic sensor configured to detect components of a magnetic field at a first location;
computing, at the sensor processing platform, a local adjustment factor based on the reference sensor signals;
receiving, at the sensor processing platform, operational sensor signals from an operational magnetic sensor configured to detect components of the magnetic field at a second location;
computing, at the sensor processing platform, an orientation representation based on the operational sensor signals;
applying the local adjustment factor to the orientation representation to generate a corrected orientation representation; and
transmitting, from the sensor processing platform, the corrected orientation representation to a computing device;
wherein the computing device is configured to track a location of an object based on the corrected orientation representation.

13. The method of claim 12, wherein the local adjustment factor includes at least one of a magnetic declination quaternion and a magnetic inclination quaternion.

14. The method of claim 12, wherein the orientation representation includes a magnetic heading quaternion.

15. The method of claim 12, wherein the orientation representation includes a magnetic declination quaternion.

16. The method of claim 12, wherein the corrected orientation representation includes a corrected quaternion and the corrected quaternion represents a three-dimensional orientation of the operational magnetic sensor.

17. The method of claim 12 wherein the local adjustment factor includes a magnetic field magnitude and the corrected orientation representation includes a corrected magnetic field magnitude.

18. The method of claim 12, wherein the computing device is configured to render a graphical representation according to the corrected orientation representation on a graphical user interface, the graphical representation depicting a three-dimensional orientation of the operational magnetic sensor.

19. A non-transitory computer-readable storage medium comprising executable instructions that, when executed by at least one electronic processor, causes the at least one electronic processor to perform the method of claim 12.

20. A device comprising:
an operational magnetic sensor configured to detect components of a magnetic field at a first location;
non-transitory computer-readable storage media storing instructions; and
at least one electronic processor configured to execute the instructions to:
receive reference sensor signals from a reference magnetic sensor configured to detect components of the magnetic field at a second location;
compute a local adjustment factor based on the reference sensor signals;
compute an orientation representation based on operational sensor signals from the operational magnetic sensor; and
apply the local adjustment factor to the orientation representation to generate a corrected orientation representation.
